(19) United States
(12) Patent Application Publication
(10) Pub. No.: US 2025/0113360 A1
(43) Pub. Date: Apr. 3, 2025

(54) METHODS AND APPARATUS FOR MITIGATING MEASUREMENT ERRORS FOR CARRIER PHASE POSITIONING DUE TO HARDWARE IMPAIRMENTS

(71) Applicant: Nokia Technologies Oy, Espoo (FI)

(72) Inventors: Abdurrahman FOUDA, Naperville, IL (US); Hyun-Su CHA, Naperville, IL (US)

(21) Appl. No.: 18/821,403

(22) Filed: Aug. 30, 2024

Related U.S. Application Data
(60) Provisional application No. 63/586,567, filed on Sep. 29, 2023.

(51) Int. Cl. H04W 72/21; H04L 5/00; H04W 64/00

(52) U.S. Cl. CPC H04W 72/21; H04L 5/0048; H04W 64/00

(57) ABSTRACT

Techniques are provided for mitigating measurement errors for carrier phase positioning due to hardware impairments. In the context of a method performed by user equipment, the method includes causing transmission of a message to request a gNB to provide at least one sounding reference signal (UL SRS) configuration satisfying a phase error less than a threshold value associated with a UE transmission phase error group identifier (UE Tx PEG ID). The method also includes receiving at least one sounding reference signal (UL SRS) configuration in response to the request. The method further includes causing SRS transmission using UL SRS resources based upon the UL SRS configuration provided by the gNB. Corresponding methods, apparatus and computer-readable storage mediums are provided for location management function (LMF) and gNB for uplink and downlink configurations.

### RELATED APPLICATION

This application claims priority to U.S. provisional Application No. 63/586,567 filed Sep. 29, 2023, which is incorporated herein by reference in its entirety.

### TECHNOLOGICAL FIELD

An example embodiment relates generally to positioning techniques utilizing carrier phase measurements and, more particularly, to techniques for mitigating phase error due to hardware implementation.

### BACKGROUND

A communication system enables communication sessions between two or more entities such as user equipment (UE), network components, base stations/access points and the like by providing connectivity between the various entities. As such, a communication system can include a communication network and one or more compatible communication devices (e.g., UEs). Communication systems continue to evolve to extend the flexibility in network usage, to provide improved security, and/or to provide users with improved network services. For instance, fourth generation (4G) wireless mobile telecommunications technology, also known as Long Term Evolution (LTE) technology, was designed to provide high-capacity mobile multimedia with high data rates particularly for human interaction. Next generation or fifth generation (5G) technology is intended to be used not only for human interaction, but also for machine type communications in so-called Internet of Things (IoT) networks.

Third generation partnership project (3GPP) has developed standards for 5G technology, including standards for next generation radio access networks and 5G network architectures that can deliver extreme broadband, ultra-robust, low latency connectivity as well as high data rate low latency connectivity for interactive media services. 5G technology improves a variety of telecommunication services offered to the end users and helps to support massive broadband that delivers gigabytes of bandwidth per second on demand for both the uplink and downlink transmissions.

Next generation networks, which are based on the 5G network architecture, utilize carrier phase positioning to quickly and accurately determine the location of a UE. However, phase errors are created by hardware impairments of a UE, a base station, a positioning reference unit or the like that hinder the speed and accuracy of carrier phase positioning. For example, phase errors may be attributable to initial phase offsets, oscillator drift, different beam/power levels as well as other hardware impairments.

### BRIEF SUMMARY

Various embodiments generally relate to techniques for mitigating measurement errors for carrier phase positioning of a user equipment (e.g., target user equipment). As such, the method, apparatus, and computer program product of an example embodiment may increase the efficiency and accuracy of carrier phase positioning.

In an example embodiment, a method is provided that includes transmitting a message to request a gNB to provide at least one sounding reference signal (UL SRS) configuration satisfying a phase error less than a threshold value associated with a UE transmission phase error group identifier (UE Tx PEG ID). The method also includes receiving at least one sounding reference signal (UL SRS) configuration in response to the request. The method further includes causing transmission of UL SRS resources based upon the UL SRS configuration provided by the gNB.

The method of an example embodiment may further include causing at least one of a positioning reference unit (PRU) or a user equipment (UE) to indicate to a location management function (LMF) at least one of the PRU Tx PEG ID or UE Tx PEG ID used for the UL SRS transmission. In an example embodiment, the maximum resource separation of UL SRS resources or the maximum time duration of one UL SRS resource defined by the UE Tx PEG ID maintains a phase error from at least a user equipment (UE) that is attributable to a hardware impairment to no more than a threshold. In an example embodiment, the maximum resource separation or the maximum time duration of one SRS resource maintains a phase error from a user equipment (UE) and the gNB that is attributable to a hardware impairment to no more than a threshold.

In an example embodiment, the maximum resource separation of UL SRS resources or the maximum time duration of one UL SRS resource maintains a phase error from at least a PRU that is attributable to a hardware impairment to no more than a threshold. In an example embodiment, the message may further include a request for the gNB to maintain a phase error that is less than a threshold value when the gNB performs carrier phase measurements for the at least one UL SRS resources. In an example embodiment, the received UL SRS configuration may satisfy a phase error less than a threshold associated with at least one of the UE or PRU transmission phase error group identifier(s) (UE Tx PEG ID(s) and/or PRU Tx PEG ID(s)).

In another example embodiment, an apparatus is provided that includes at least one processor and at least one memory storing instructions, that, when executed by the at least one processor, cause the apparatus to transmit a message to request a gNB to provide at least one sounding reference signal (UL SRS) configuration satisfying a phase error less than a threshold value associated with a UE transmission phase error group identifier (UE Tx PEG ID). The apparatus is further caused to receive at least one sounding reference signal (UL SRS) configuration in response to the request. The apparatus is also caused to cause transmission of UL SRS resources based upon the UL SRS configuration provided by the gNB.

The apparatus of an example embodiment is further caused to cause the apparatus to cause at least one of a positioning reference unit (PRU) or a user equipment (UE) to indicate to a location management function (LMF) at least one of the PRU Tx PEG ID or UE Tx PEG ID used for the UL SRS transmission. In an example embodiment, a maximum resource separation of UL SRS resources or the maximum time duration of one UL SRS resource defined by the UE Tx PEG ID maintains a phase error from at least a user equipment (UE) that is attributable to a hardware impairment to no more than a threshold. In an example embodiment, the maximum resource separation or the maximum time duration of one SRS resource maintains a phase error from a user equipment (UE) and the gNB that is attributable to a hardware impairment to no more than a threshold.

In another example embodiment, the maximum resource separation of UL SRS resources or the maximum time duration of one UL SRS resource maintains a phase error from at least a PRU that is attributable to a hardware impairment to no more than a threshold. In an example embodiment, the message may further include a request for the gNB to maintain a phase error that is less than a threshold value when the gNB performs carrier phase measurements for the at least one UL SRS resources. In an example embodiment, the received UL SRS configuration satisfies a phase error less than a threshold value associated with at least one of the UE or PRU transmission phase error group identifier(s) (UE Tx PEG ID(s) and/or PRU Tx PEG ID(s)).

In a further example embodiment, a non-transitory computer-readable storage medium is provided that includes program instructions stored thereon for transmitting a message to request a gNB to provide at least one sounding reference signal (UL SRS) configuration satisfying a phase error less than a threshold value associated with a UE transmission phase error group identifier (UE Tx PEG ID). The program instructions are also for receiving at least one sounding reference signal (UL SRS) configuration in response to the request. The program instructions are further for causing transmission of UL SRS resources based upon the UL SRS configuration provided by the gNB.

The program instructions of an example embodiment may further include program instructions for causing at least one of a positioning reference unit (PRU) or a user equipment (UE) to indicate to a location management function (LMF) at least one of the PRU Tx PEG ID or UE Tx PEG ID used for the UL SRS transmission.

In yet another example embodiment, an apparatus is provided that includes means for transmitting a message to request a gNB to provide at least one sounding reference signal (UL SRS) configuration satisfying a phase error less than a threshold value associated with a UE transmission phase error group identifier (UE Tx PEG ID). The apparatus also includes means for receiving at least one sounding reference signal (UL SRS) configuration in response to the request. The apparatus further includes means for causing transmission of UL SRS resources based upon the UL SRS configuration provided by the gNB.

The apparatus of an example embodiment may further include means for causing at least one of a positioning reference unit (PRU) or a user equipment (UE) to indicate to a location management function (LMF) at least one of the PRU Tx PEG ID or UE Tx PEG ID used for the UL SRS transmission.

In an example embodiment, a method is provided that includes receiving one or more indications of at least one position reference unit (PRU) transmission phase error group identifier(s) (PRU Tx PEG ID(s)) for uplink sounding reference signal transmission (UL SRS), wherein the PRU Tx PEG ID(s) defines a maximum resource separation of UL SRS resources or the maximum time duration of one UL SRS resource. The method also includes requesting that a gNB to perform carrier phase (CP) measurements for the UL SRS resources associated with the PRU Tx PEG ID(s) and report the CP measurements. The method also includes creating single and double differenced CP measurements based on the received PRU Tx PEG ID(s). The method further includes estimating a location of a user equipment (UE) based on the CP measurements.

In an example embodiment, the method may also include receiving the CP measurements from the gNB. In an example embodiment, the method may further include utilizing the CP measurements from the PRU and the UE for which the Tx PEG ID(s) is (are) identical to create the single-differenced and double-differenced CP measurements. In an example embodiment, the maximum resource separation maintains a phase error from at least the UE that is attributable to a hardware impairment to no more than a predefined threshold. In another example embodiment, the maximum resource separation maintains a phase error from at least the PRU that is attributable to a hardware impairment to no more than a predefined threshold. In yet another example embodiment, the maximum resource separation maintains a phase error from the UE and the gNB that is attributable to a hardware impairment to no more than a predefined threshold.

In another example embodiment, an apparatus is provided that includes at least one processor and at least one memory storing instructions that, when executed by the at least one processor, cause the apparatus to receive one or more indications of at least one position reference unit (PRU) transmission phase error group identifier(s) (PRU Tx PEG ID(s)) for uplink sounding reference signal transmission (UL SRS), wherein the PRU Tx PEG ID(s) defines a maximum resource separation of UL SRS resources or the maximum time duration of one UL SRS resource. The apparatus is also caused to request that a gNB to perform carrier phase (CP) measurements for the UL SRS resources as associated with the PRU Tx PEG ID(s) and report the CP measurements. The apparatus is also caused to create single and double differenced CP measurements based on the received PRU Tx PEG ID(s). The apparatus is further caused to estimate a location of a user equipment (UE) based on the CP measurements.

In an example embodiment, the instructions may further cause the apparatus to receive the CP measurements from the gNB. In the example embodiment, the instructions may further cause the apparatus to utilize the CP measurements from the PRU and the UE for which the Tx PEG ID(s) is (are) identical to create the single-differenced and double-differenced CP measurements. In an example embodiment, the maximum resource separation maintains a phase error from at least the UE that is attributable to a hardware impairment to no more than a predefined threshold. In another example embodiment, the maximum resource separation maintains a phase error from at least the PRU that is attributable to a hardware impairment to no more than a predefined threshold. In another example embodiment, the maximum resource separation maintains a phase error from the UE and the gNB that is attributable to a hardware impairment to no more than a predefined threshold.

In a further example embodiment, a non-transitory computer-readable storage medium is provided that includes program instructions stored thereon for receiving one or more indications of at least one position reference unit (PRU) transmission phase error group identifier(s) (PRU Tx PEG ID(s)) for uplink sounding reference signal transmission (UL SRS), wherein the PRU Tx PEG ID(s) defines a maximum resource separation for UL SRS resources. The program instructions are also for requesting that a gNB to perform carrier phase (CP) measurements for the UL SRS resources as defined by the PRU Tx PEG ID(s). The program instructions are also for creating single and double differenced CP measurements based on the received PRU Tx PEG ID(s). The program instructions are further for estimating a location of a user equipment (UE) based on the CP measurements.

In an example embodiment, the program instructions may also include program instructions for receiving the CP measurements from the gNB. In another example embodiment, the program instructions may further include program instructions for utilizing the CP measurements from the PRU and the UE for which the Tx PEG ID(s) is (are) identical to create the single-differenced and double-differenced CP measurements.

In yet another example embodiment, an apparatus is provided that includes means for receiving one or more indications of at least one position reference unit (PRU) transmission phase error group identifier(s) (PRU Tx PEG ID(s)) for uplink sounding reference signal transmission (UL SRS), wherein the PRU Tx PEG ID(s) defines a maximum resource separation for UL SRS resources. The apparatus may also include means for requesting that a gNB to perform carrier phase (CP) measurements for the UL SRS resources as defined by the PRU Tx PEG ID(s). The apparatus may also include means for creating single and double differenced CP measurements based on the received PRU Tx PEG ID(s). The apparatus may further include means for estimating a location of a user equipment (UE) based on the CP measurements.

In an example embodiment, the apparatus may also include means for receiving the CP measurements from the gNB. In another example embodiment, the apparatus may further include means for utilizing the CP measurements from the PRU and the UE for which the Tx PEG ID(s) is (are) identical to create the single-differenced and double-differenced CP measurements.

In an example embodiment, a method is provided that includes receiving a request from a user equipment (UE) to provide at least one uplink sounding reference signal (UL SRS) configuration to maintain no more than a first maximum resource separation of UL SRS resources or a first maximum time duration of one UL SRS resource from the UE as defined by a first UE transmission phase error group identifier (UE Tx PEG ID). The method also includes receiving a request from at least one positioning reference unit (PRU) to maintain no more than a second maximum resource separation of UL SRS resources or a second maximum time duration of one UL SRS resource from the PRU as defined by a second PRU Tx PEG ID. The method also includes receiving a request to perform carrier phase (CP) measurements based on the first UE Tx PEG ID and second PRU Tx PEG IDs. The method further includes, based on the first UE Tx PEG IDs and second PRU Tx PEG ID, performing the CP measurements of the SRS resources that have been received.

In an example embodiment, the method may also include causing transmission of information regarding the CP measurements to at least a location management function. In an example embodiment, in an instance in which the first and second maximum resource separations or maximum time durations are different, performing the CP measurements comprises performing the CP measurements for UL SRS resources having a maximum resource separation or UL SRS resource having a maximum time duration of no more than a smaller of the first and second maximum resource separations or first and second maximum time durations.

In the example embodiment, performing the CP measurements comprises preventing performance of the CP measurements for UL SRS resources having a resource separation that is greater than the smaller of the first and second maximum resource separations or the first and second maximum time durations. In an example embodiment, the first maximum resource separation or the first maximum time duration maintains a phase error from the UE that is attributable to a hardware impairment to no more than a first threshold, and wherein the second maximum resource separation maintains a phase error from the PRU that is attributable to a hardware impairment to no more than a second threshold.

In another example embodiment, an apparatus is provided that includes at least one processor and at least one memory storing instructions that, when executed by the at least one processor, cause the apparatus to receive a request from a user equipment (UE) to provide at least one uplink sounding reference signal (UL SRS) configuration to maintain no more than a first maximum resource separation of UL SRS resources or a first maximum time duration of one UL SRS resource from the UE as defined by a first UE transmission phase error group identifier (UE Tx PEG ID). The apparatus is also caused to receive a request from at least one positioning reference unit (PRU) to maintain no more than a second maximum resource separation of UL SRS resources or a second maximum time duration of one UL SRS resource from the PRU as defined by a second PRU Tx PEG ID. The apparatus is also caused to receive a request to perform carrier phase (CP) measurements based on the first UE Tx PEG ID and second PRU Tx PEG ID. The apparatus is further caused, based on the first UE Tx PEG ID and second PRU Tx PEG ID, performing the CP measurements of the SRS resources that have been received.

In an example embodiment, the instructions may further cause the apparatus to cause transmission of information regarding the CP measurements to at least a location management function. In an example embodiment, in an instance in which the first and second maximum resource separations or maximum time durations are different, performing the CP measurements comprises performing the CP measurements for UL SRS resources having a maximum resource separation or UL SRS resource having maximum time duration of no more than a smaller of the first and second maximum resource separations or the first and second maximum time durations.

In an example embodiment, the performing of the CP measurements comprises preventing performance of the CP measurements for UL SRS resources having a resource separation that is greater than the smaller of the first and second maximum resource separations or the first and second maximum time durations. In an example embodiment, the first maximum resource separation or the first maximum time duration maintains a phase error from the UE that is attributable to a hardware impairment to no more than a first threshold, and wherein the second maximum resource separation or maximum time duration maintains a phase error from the PRU that is attributable to a hardware impairment to no more than a second threshold.

In a further example embodiment, a non-transitory computer-readable storage medium is provided that includes program instructions stored thereon for receiving a request from a user equipment (UE) to provide at least one uplink sounding reference signal (UL SRS) configuration to maintain no more than a first maximum resource separation of UL SRS resources or a first maximum time duration of one UL SRS resource from the UE as defined by a first UE transmission phase error group identifier (UE Tx PEG ID). The program instructions are also for receiving a request from at least one positioning reference unit (PRU) to maintain no more than a second maximum resource separation of UL SRS resources or a second maximum time duration of one UL SRS resource from the PRU as defined by a second PRU Tx PEG ID. The program instructions are also for receiving a request to perform carrier phase (CP) measurements based on the first UE Tx PEG ID and second PRU Tx PEG ID. The program instructions are further for, based on the first UE Tx PEG ID and second PRU Tx PEG ID, performing the CP measurements of the SRS resources that have been received.

In an example embodiment, the program instructions may also include program instructions for causing transmission of information regarding the CP measurements to at least a location management function. In an example embodiment, in an instance in which the first and second maximum resource separations or maximum time durations are different, the program instructions for performing the CP measurements may include program instructions for performing the CP measurements for UL SRS resources having a maximum resource separation or UL SRS resource having a maximum time duration of no more than a smaller of the first and second maximum resource separations or first and second maximum time durations. In the example embodiment, the program instructions for performing the CP measurements include program instructions for preventing performance of the CP measurements for UL SRS resources having a resource separation that is greater than the smaller of the first and second maximum resource separations or the first and second maximum time durations.

In yet another example embodiment, an apparatus is provided that includes means for receiving a request from a user equipment (UE) to provide at least one uplink sounding reference signal (UL SRS) configuration to maintain no more than a first maximum resource separation of UL SRS resources or a first maximum time duration of one UL SRS resource from the UE as defined by a first UE transmission phase error group identifier (UE Tx PEG ID). The apparatus also includes means for receiving a request from at least one positioning reference unit (PRU) to maintain no more than a second maximum resource separation of UL SRS resources or a second maximum time duration of one UL SRS resource from the PRU as defined by a second PRU Tx PEG ID. The apparatus also includes means for receiving a request to perform carrier phase (CP) measurements based on the first UE Tx PEG ID and second PRU Tx PEG ID. The apparatus further includes means for, based on the first UE Tx PEG ID and second PRU Tx PEG ID, performing the CP measurements of the SRS resources that have been received.

In an example embodiment, the apparatus may also include means for causing transmission of information regarding the CP measurements to at least a location management function. In an example embodiment, in an instance in which the first and second maximum resource separations or maximum time durations are different, the means for performing the CP measurements may include means for performing the CP measurements for UL SRS resources having a maximum resource separation or UL SRS resource having a maximum time duration of no more than a smaller of the first and second maximum resource separations or first and second maximum time durations. In the example embodiment, the means for performing the CP measurements include means for preventing performance of the CP measurements for UL SRS resources having a resource separation that is greater than the smaller of the first and second maximum resource separations or the first and second maximum time durations.

In an example embodiment, a method is provided that includes indicating at least one transmission and reception point (TRP) transmission phase error group identifier (TRP Tx PEG ID) to be used for downlink (DL) positioning reference signal (PRS) transmission, wherein the TRP Tx PEG ID defines a maximum DL PRS resource separation. The method also includes causing transmission of DL PRS resources based upon the TRP Tx PEG ID so as to maintain no more than the maximum DL PRS resource separation.

In an example embodiment, the maximum DL PRS resource separation maintains a phase error from at least one TRP that is attributable to a hardware impairment to no more than a predefined threshold.

In another example embodiment, an apparatus is provided that includes at least one processor and at least one memory storing instructions that, when executed by the at least one processor, cause the apparatus to indicate at least one transmission and reception point (TRP) transmission phase error group identifier (TRP Tx PEG ID) to be used for downlink (DL) positioning reference signal (PRS) transmission, wherein the TRP Tx PEG ID defines a maximum DL PRS resource separation. The apparatus is further caused to cause transmission of DL PRS resources based upon the TRP Tx PEG ID so as to maintain no more than the maximum DL PRS resource separation.

In a further example embodiment, a non-transitory computer-readable storage medium is provided that includes program instructions stored thereon for indicating at least one transmission and reception point (TRP) transmission phase error group identifier (TRP Tx PEG ID) to be used for downlink (DL) positioning reference signal (PRS) transmission, wherein the TRP Tx PEG ID defines a maximum DL PRS resource separation. The program instructions are further for causing transmission of DL PRS resources based upon the TRP Tx PEG ID so as to maintain no more than the maximum DL PRS resource separation.

In yet another example embodiment, an apparatus is provided that includes means for indicating at least one transmission and reception point (TRP) transmission phase error group identifier (TRP Tx PEG ID) to be used for downlink (DL) positioning reference signal (PRS) transmission, wherein the TRP Tx PEG ID defines a maximum DL PRS resource separation. The apparatus further includes means for causing transmission of DL PRS resources based upon the TRP Tx PEG ID so as to maintain no more than the maximum DL PRS resource separation.

In an example embodiment, a method is provided that includes receiving an indication at least one transmission and reception point (TRP) transmission phase error group identifier (TRP Tx PEG ID) to be used for downlink (DL) positioning reference signal (PRS) transmission, wherein the TRP Tx PEG ID defines a maximum DL PRS resource separation. The method also includes requesting at least one of a user equipment (UE) or a positioning reference unit (PRU) to perform and report carrier phase (CP) measurements based on DL PRS resources that have no more than the maximum DL PRS resource separation defined by the TRP Tx PEG ID. The method further includes receiving information regarding the CP measurements from the PRU along with an indication of the TRP Tx PEG ID(s).

The method of an example embodiment may further comprise forwarding the CP measurements of the PRU along with the corresponding TRP Tx PEG ID(s) to the UE. In the example embodiment, the method may further include causing an instruction to be transmitted toward the UE for the UE to use specific TRP Tx PEG ID(s) associated with CP measurements of the PRU which is (are) identical to the UE Tx PEG ID(s) associated with CP measurements of the UE to create double-differenced CP measurements.

In an example embodiment, the method may also include receiving information regarding the CP measurements from the UE along with an indication of the associated TRP Tx PEG IDs. In the example embodiment, the method may further include creating the double-differenced CP measurements and calculating the location of the UE using the CP measurements from the PRU and the UE having identical TRP Tx PEG IDs.

In another example embodiment, an apparatus is provided that includes at least one processor and at least one memory storing instructions that, when executed by the at least one processor, cause the apparatus to receive an indication at least one transmission and reception point (TRP) transmission phase error group identifier (TRP Tx PEG ID) to be used for downlink (DL) positioning reference signal (PRS) transmission, wherein the TRP Tx PEG ID defines a maximum DL PRS resource separation. The apparatus is also caused to request at least one of a user equipment (UE) or a positioning reference unit (PRU) to perform and report carrier phase (CP) measurements based on DL PRS resources that have no more than the maximum DL PRS resource separation defined by the TRP Tx PEG ID. The apparatus is further caused to receive information regarding the CP measurements from the PRU along with an indication of the TRP Tx PEG ID(s).

In an example embodiment, the apparatus is also caused to forward the CP measurements of the PRU along with the corresponding TRP Tx PEG ID(s) to the UE. In the example embodiment, the apparatus may be further caused to cause an instruction to be transmitted toward the UE for the UE to use specific TRP Tx PEG ID(s) associated with CP measurements of the PRU which is (are) identical to the UE Tx PEG ID(s) associated with CP measurements of the UE to create double-differenced CP measurements.

In an example embodiment, the apparatus may also be caused to receive information regarding the CP measurements from the UE along with an indication of the associated TRP Tx PEG IDs. In the example embodiment, the apparatus may be further caused to create the double-differenced CP measurements and calculating the location of the UE using the CP measurements from the PRU and the UE having identical TRP Tx PEG IDs.

In a further example embodiment, a non-transitory computer-readable storage medium is provided that includes program instructions stored thereon for receiving an indication at least one transmission and reception point (TRP) transmission phase error group identifier (TRP Tx PEG ID) to be used for downlink (DL) positioning reference signal (PRS) transmission, wherein the TRP Tx PEG ID defines a maximum DL PRS resource separation. The program instructions are also for requesting at least one of a user equipment (UE) or a positioning reference unit (PRU) to perform and report carrier phase (CP) measurements based on DL PRS resources that have no more than the maximum DL PRS resource separation defined by the TRP Tx PEG ID. The program instructions are further for receiving information regarding the CP measurements from the PRU along with an indication of the TRP Tx PEG ID(s).

The program instructions of an example embodiment are further configured for forwarding the CP measurements of the PRU along with the corresponding TRP Tx PEG ID(s) to the UE. In the example embodiment, the program instructions are further configured for causing an instruction to be transmitted toward the UE for the UE to use specific TRP Tx PEG ID(s) associated with CP measurements of the PRU which is (are) identical to the UE Tx PEG ID(s) associated with CP measurements of the UE to create double-differenced CP measurements.

The program instructions of another example embodiment are further configured for receiving information regarding the CP measurements from the UE along with an indication of the associated TRP Tx PEG IDs. In the example embodiment, the program instructions are further configured for creating the double-differenced CP measurements and calculating the location of the UE using the CP measurements from the PRU and the UE having identical TRP Tx PEG IDs.

In yet another example embodiment, an apparatus is provided that includes means for receiving an indication at least one transmission and reception point (TRP) transmission phase error group identifier (TRP Tx PEG ID) to be used for downlink (DL) positioning reference signal (PRS) transmission, wherein the TRP Tx PEG ID defines a maximum DL PRS resource separation. The apparatus also includes means for requesting at least one of a user equipment (UE) or a positioning reference unit (PRU) to perform and report carrier phase (CP) measurements based on DL PRS resources that have no more than the maximum DL PRS resource separation defined by the TRP Tx PEG ID. The apparatus further includes means for receiving information regarding the CP measurements from the PRU along with an indication of the TRP Tx PEG ID(s).

The apparatus of an example embodiment may further include means for forwarding the CP measurements of the PRU along with the corresponding TRP Tx PEG ID(s) to the UE. In the example embodiment, the apparatus may further include means for causing an instruction to be transmitted toward the UE for the UE to use specific TRP Tx PEG ID(s) associated with CP measurements of the PRU which is (are) identical to the UE Tx PEG ID(s) associated with CP measurements of the UE to create double-differenced CP measurements.

The apparatus of another example embodiment may further comprise means for receiving information regarding the CP measurements from the UE along with an indication of the associated TRP Tx PEG IDs. In the example embodiment, the apparatus may further include means for creating the double-differenced CP measurements and calculating the location of the UE using the CP measurements from the PRU and the UE having identical TRP Tx PEG IDs.

In an example embodiment, a method is provided that includes receiving information regarding a downlink positioning reference signal (DL PRS) resource configuration from a location management function (LMF) along with a transmission and reception point (TRP) transmission phase error group identifier(s) (TRP Tx PEG ID(s)), wherein a TRP Tx PEG ID defines a maximum resource separation of the DL PRS resources from which carrier phase (CP) measurements are obtained. The method further includes using the CP measurements of aa positioning reference unit having the same TRP Tx PEG ID(s) as the TRP Tx PEG ID(s) associated with CP measurements captured by a user equipment (UE) to create double-differenced carrier phase (CP) measurements.

In another example embodiment, an apparatus is provided that includes at least one processor and at least one memory storing instructions that, when executed by the at least one processor, cause the apparatus to receive information a downlink positioning reference signal (DL PRS) resource configuration from a location management function (LMF) along with a transmission and reception point (TRP) transmission phase error group identifier(s) (TRP Tx PEG ID(s)), wherein a TRP Tx PEG ID defines a maximum resource separation of the DL PRS resources from which carrier phase (CP) measurements are obtained. The apparatus is further caused to use the CP measurements of a positioning reference unit (PRU) having the same TRP Tx PEG ID(s) as the TRP Tx PEG ID(s) associated with CP measurements captured by a user equipment (UE) to create double-differenced carrier phase (CP) measurements.

In a further example embodiment, a non-transitory computer-readable storage medium is provided that includes program instructions stored thereon for receiving information a downlink positioning reference signal (DL PRS) resource configuration from a location management function (LMF) along with a transmission and reception point (TRP) transmission phase error group identifier(s) (TRP Tx PEG ID(s)), wherein a TRP Tx PEG ID defines a maximum resource separation of the DL PRS resources from which carrier phase (CP) measurements are obtained. The program instructions are further for using the CP measurements of a positioning reference unit (PRU) having the same TRP Tx PEG ID(s) as the TRP Tx PEG ID(s) associated with CP measurements captured by a user equipment (UE) to create double-differenced carrier phase (CP) measurements.

In yet another example embodiment, an apparatus is provided that includes means for receiving information regarding a downlink positioning reference signal (DL PRS) resource configuration from a location management function (LMF) along with a transmission and reception point (TRP) transmission phase error group identifier(s) (TRP Tx PEG ID(s)), wherein a TRP Tx PEG ID defines a maximum resource separation of the DL PRS resources from which carrier phase (CP) measurements are obtained. The apparatus further includes means for using the CP measurements of a positioning reference unit (PRU) having the same TRP Tx PEG ID(s) as the TRP Tx PEG ID(s) associated with CP measurements captured by a user equipment (UE) to create double-differenced carrier phase (CP) measurements.

In an example embodiment, a method is provided that includes performing a carrier phase (CP) measurement(s) using downlink positioning reference signal (DL PRS) resources that have no more than a maximum DL PRS resource separation as defined by a transmission and reception point (TRP) transmission phase error group identifier(s) (Tx PEG ID(s)). The method further includes causing information regarding the CP measurement(s) made for the indicated TRP Tx PEG ID(s) to be transmitted toward a location management function (LMF) along with corresponding TRP Tx PEG ID(s).

In another example embodiment, an apparatus is provided that includes at least one processor and at least one memory storing instructions that, when executed by the at least one processor, cause the apparatus to perform a carrier phase (CP) measurement(s) using downlink positioning reference signal (DL PRS) resources that have no more than a maximum DL PRS resource separation as defined by a transmission and reception point (TRP) transmission phase error group identifier(s) (Tx PEG ID(s)). The apparatus is further caused to cause information regarding the CP measurement(s) made for the indicated TRP Tx PEG ID(s) to be transmitted toward a location management function (LMF) along with corresponding TRP Tx PEG ID(s).

In a further example embodiment, a non-transitory computer-readable storage medium is provided that includes program instructions stored thereon for performing a carrier phase (CP) measurement(s) using downlink positioning reference signal (DL PRS) resources that have no more than a maximum DL PRS resource separation as defined by a transmission and reception point (TRP) transmission phase error group identifier(s) (Tx PEG ID(s)). The program instructions are further for causing information regarding the CP measurement(s) made for the indicated TRP Tx PEG ID(s) to be transmitted toward a location management function (LMF) along with corresponding TRP Tx PEG ID(s).

In yet another example embodiment, an apparatus is provided that includes means performing a carrier phase (CP) measurement(s) using downlink positioning reference signal (DL PRS) resources that have no more than a maximum DL PRS resource separation as defined by a transmission and reception point (TRP) transmission phase error group identifier(s) (Tx PEG ID(s)). The apparatus further includes means for causing information regarding the CP measurement(s) made for the indicated TRP Tx PEG ID(s) to be transmitted toward a location management function (LMF) along with corresponding TRP Tx PEG ID(s).

The above summary is provided merely for purposes of summarizing some example embodiments to provide a basic understanding of some aspects of the invention. Accordingly, it will be appreciated that the above-described embodiments are merely example and should not be construed to narrow the scope or spirit of the disclosure in any way. It will be appreciated that the scope of the disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates an example of a communication system that may support carrier phase positioning in accordance with an example embodiment of the present disclosure;

FIG. 2 illustrates a block diagram of an apparatus that may be configured in accordance with an example embodiment of the present disclosure;

FIG. 3 illustrates a schematic diagram of new radio carrier phase positioning in accordance with an example embodiment of the present disclosure;

FIG. 4 illustrates a signal diagram for uplink carrier phase positioning in accordance with an example embodiment of the present disclosure;

FIG. 5 illustrates a signal diagram for downlink carrier phase UE-based mode positioning in accordance with an example embodiment of the present disclosure;

FIG. 6 illustrates a signal diagram for downlink carrier phase UE-assisted mode positioning in accordance with an example embodiment of the present disclosure;

FIG. 7 is a flowchart illustrating operations implemented by a UE or PRU in accordance with an example embodiment of the present disclosure;

FIG. 8 is a flowchart illustrating operations implemented by a location management function in an uplink configuration in accordance with an example embodiment of the present disclosure;

FIG. 9 is a flowchart illustrating operations implemented by a base station in an uplink configuration in accordance with an example embodiment of the present disclosure;

FIG. 10 is a flowchart illustrating operations implemented by a base station in a downlink configuration in accordance with an example embodiment of the present disclosure; and

FIG. 11 is a flowchart illustrating operations implemented by a location management function in a downlink configuration in accordance with an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

The term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of. Furthermore, to the extent that the terms “includes” and “including,” and variants thereof are used in either the detailed description or the claims, these terms are intended to be inclusive in a manner similar to the term “comprising.”

The phrases “in one embodiment,” “in one example embodiment,” “according to one embodiment,” “according to one example embodiment,” “in some embodiments,” “in some example embodiments,” “in various embodiments”, “in various example embodiments,” and the like generally refer to the fact that the particular feature, structure, or characteristic following the phrase may be included in at least one example embodiment of the subject disclosure, but not necessarily all example embodiments of the subject disclosure. Thus, the particular feature, structure, or characteristic may be included in more than one example embodiment of the subject disclosure such that these phrases do not necessarily refer to the same example embodiment.

As used herein, the terms “example,” “exemplary,” and the like are used to mean “serving as an example, instance, or illustration.” Any implementation, aspect, or design described herein as “example” or “exemplary” is not necessarily to be construed as preferred or advantageous over other implementations, aspects, or designs. Rather, use of the terms “example,” “exemplary,” and the like are intended to present concepts in a concrete fashion.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Examples of non-transitory computer-readable media may include, but are not limited to, one or more types of hardware memory, non-transitory tangible media (for example, one or more magnetic storage disks, one or more optical disks, one or more USB flash drives), computer system memory or random-access memory (such as, DRAM, SRAM, EDO RAM), and the like.

As used herein, “at least one of the following: <a list of two or more elements>” and “at least one of <a list of two or more elements>” and similar wording, where a list of two or more elements are joined by “and”, “or”, or “and/or”, means at least any one of the elements, or at least any two or more of the elements, or at least all of the elements.

An example embodiment will be illustrated herein in conjunction with example communication systems and associated techniques for mitigating measurement errors in carrier phase positioning due to hardware impairments. It should be understood, however, that the scope of the claims is not limited to particular types of communication systems and/or processes disclosed. An example embodiment can be implemented in a network (e.g., a core network) or a terminal device (e.g., a user equipment) of a communication system, using one or more processes and operations. For example, although illustrated in the context of wireless cellular systems utilizing 3GPP system elements such as a 3GPP next generation core network, the disclosed example embodiments can be adapted in a straightforward manner to a variety of other types of communication systems. Additionally, while the subject disclosure may describe various example embodiments in conjunction with a fifth generation (5G) communications system, the subject disclosure also applies to and comprises other networks and network technologies, such as 3G, 4G, Long Term Evolution (LTE), sixth generation (6G), etc. without limitation.

In accordance with an illustrative example embodiment implemented in a 5G communication system environment, one or more 3GPP technical specifications (TS) and technical reports (TR) provide further explanation of user equipment and core network elements/entities/functions and/or operations performed by the user equipment and the core network elements/entities/functions, e.g., 3GPP TS 38.455 and TS 37.355. Other 3GPP TS/TR documents provide other conventional details that one of ordinary skill in the art will realize. However, while an example embodiment is well-suited for implementation associated with the above-mentioned 3GPP standards for 5G, alternative embodiments are not necessarily intended to be limited to any particular standards.

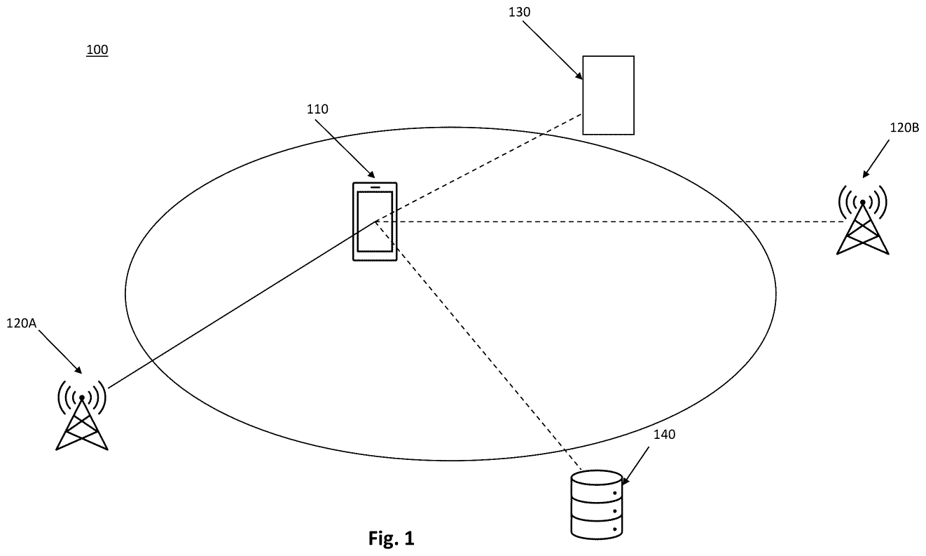

As illustrated in FIG. 1, a communication system 100 is provided in accordance with an example embodiment of the subject disclosure. In one or more example embodiments, the communication system 100 can include one or more terminal devices (e.g., user equipment, and/or positioning reference unit) and one or more networks (e.g., one or more communication networks, one or more network components, etc.). In an example embodiment, the communication system 100 is an environment that includes or corresponds to a 5G communication system (e.g., a 5G communication network) associated with one or more terminal devices (e.g., user equipment, positioning reference unit) and/or one or more networks (e.g., one or more communication networks, one or more network components, etc.) that support 5G communications. However, the depiction of communication system 100 in FIG. 1 is not intended to limit or otherwise confine an example embodiment described and contemplated herein to any particular configuration of elements or networks, nor is it intended to exclude any alternative configurations or systems for the set of configurations and systems that can be used in connection with certain embodiments of the subject disclosure. Rather, FIG. 1, and the communication system 100 disclosed therein is merely presented to provide an example basis and context for the facilitation of describing some of the features, aspects, and uses of the methods, apparatuses, and computer program products disclosed and contemplated herein. It will be understood that while many of the aspects and components presented in FIG. 1 are shown as discrete, separate elements, other configurations may be used in connection with the methods, apparatuses, and computer programs described herein, including configurations that combine, omit, and/or add aspects and/or components.

In some example embodiments, the communication system 100 may comprise at least one user equipment (UE) 110, at least one network component 120 (e.g., gNB), at least one location management function (LMF) or other server 140 that are capable of being in communication with each other, and/or at least one position reference unit (PRU) 130 that is capable of being in communication with each other and to receive uplink (UL) and/or downlink (DL) transmissions. The at least one network component 120 can be a radio access network (RAN) component, a core network (CN) component, a data network (DN) component, an application server component, an application function, and/or another type of network component. In one or more example embodiments, the at least one network component 120, may be a network element and may be embodied by any of a variety of access points including, for example, a Node B, e.g., a gNB, a base station or the like. The gNBs may be associated with one or more TRPs, such as antennas and/or antenna panels, that are configured to send and receive signals based on control provided by the gNB. The UEs 110 may be configured to operate in two or more frequency bands, such as three or four frequency bands in some example embodiments.

As described below, the apparatus, method and computer program product of an example embodiment are configured to mitigate phase errors during a carrier phase positioning process due to hardware impairments of or between one or more communicating components. By way of example, the system 100 may be deployed within a radio access architecture based on long term evolution advanced (LTE Advanced, LTE-A) and/or new radio (NR, 5G). However, the system may be deployed in other network architectures including within other communication networks including, for example, other communication networks developed in the future, e.g., sixth generation (6G) networks, as well as any of a number of existing networks including a universal mobile telecommunications system (UMTS) radio access network (UTRAN or E-UTRAN), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

The UE 110 and the PRU 130 may be any type of terminal device to which resources on the air interface are allocated and assigned. Although the PRU has a fixed and defined location, the UEs may be a portable computing device such as a wireless mobile communication device including, but not limited to, the following types of devices: a mobile station (mobile phone), smartphone, a virtual reality device, an augmented reality device, personal digital assistant (PDA), handset, device using a wireless modem (alarm or measurement device, etc.), laptop and/or touch screen computer, tablet, game console, notebook, and multimedia device. The user equipment may also be called a subscriber unit, mobile station, remote terminal, access terminal, or user terminal just to mention but a few names or apparatuses.

The at least one location management function (LMF) 140 may be a network element and may be embodied by any of a variety of network nodes or functions including, for example, a server, a repository, a memory device, or the like. As noted above, in one example embodiment, the LMF may be embodied by one or more of the UEs or PRUs 130.

In some example embodiments, the at least one network component 120 can be related to one or more cellular access points. In some example embodiments, the at least one network component 120 may define and/or service one or more cells. In one or more example embodiments, one or more access points may be in communication with a network, such as a core network via a gateway, such that the one or more access points establish cellular radio access networks by which the UE 110 may communicate with the at least one network component 120.

Although not shown, the communication system 100 may also include a controller associated with one or more of the access points, such as, base stations, for example, to facilitate operation of the access points and management of the UE 110 in communication therewith. As shown in FIG. 1, the communication system 100 may optionally also include one or more wireless local area networks (WLANs), each of which may be serviced by a WLAN access point configured to establish wireless communications with the UE 110. As such, the UE 110 may communicate with the at least one network component 120 via a WLAN access point. In various example embodiments, the at least one network component 120 may consist of additional network elements as routers, switches, servers, gateways, and/or controllers to facilitate communication with the UE 110.

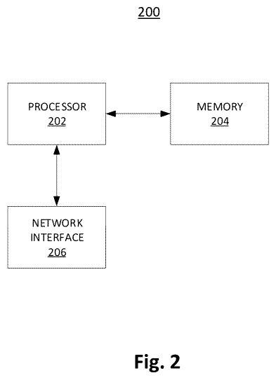

Referring now to FIG. 2, an example apparatus 200 is provided. The apparatus 200 may be embodied by any one of a UE 110, a network component 120 (e.g., gNB or other base station), a PRU 130 or by the LMF 140. The apparatus 200 may include processor 202, memory 204, and network interface 206. The apparatus 200 may be configured to execute the operations described herein. Although these components are described with respect to the performance of various functions, it should be understood that the particular implementations necessarily include the use of particular hardware. It should also be understood that certain of these components may include similar or common hardware. For example, two sets of circuitries may both leverage use of the same processor, network interface, storage medium, or the like to perform their associated functions, such that duplicate hardware is not required for each set of circuitries.

In some example embodiments, the processor 202 (and/or co-processor or any other processing circuitry assisting or otherwise associated with the processor) may be in communication with the memory 204 via a bus for passing information among components of the apparatus 200. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus 200 to carry out various functions in accordance with an example embodiment disclosed herein.

The processor 202 may be embodied in a number of different ways and may, for example, include one or more processing devices configured to perform independently. In some non-limiting embodiments, the processor 202 may include one or more processors configured in tandem via a bus to enable independent execution of instructions, pipelining, and/or multithreading. The use of the term “processor” may be understood to include a single core processor, a multi-core processor, multiple processors internal to the apparatus 200, and/or remote or “cloud” processors.

In some example embodiments, the processor 202 may be configured to execute instructions stored in the memory 204 and/or circuitry otherwise accessible to the processor 202. In some example embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment disclosed herein while configured accordingly. Alternatively, as another example, when the processor 202 is embodied as an executor of software instructions, the instructions may specifically configure the processor 202 to perform the algorithms and/or operations described herein when the instructions are executed.

In some example embodiments, the apparatus 200 may optionally include input/output circuitry that may, in turn, be in communication with processor 202 to provide output to a user and/or other entity and, in some example embodiments, to receive an indication of an input. The input/output circuitry may comprise a user interface and may include a display, and may comprise a web user interface, a mobile application, a query-initiating computing device, a kiosk, or the like. In some example embodiments, the input/output circuitry may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The network interface 206 may be any means such as a device or circuitry embodied in either hardware or a combination of hardware and software that is configured to receive and/or transmit data from/to a network, e.g., one or more of the RAN components 120 and/or any other device, circuitry, or module in communication with the apparatus 200. In this regard, the network interface 206 may include, for example, a network interface for enabling communications with a wired or wireless communication network. For example, the network interface 206 may include one or more network interface cards, antennae, buses, switches, routers, modems, and supporting hardware and/or software, or any other device suitable for enabling communications via a network. Additionally, or alternatively, the network interface 206 may include the circuitry for interacting with the antenna/antennae to cause transmission of signals via the antenna/antennae or to handle receipt of signals received via the antenna/antennae.

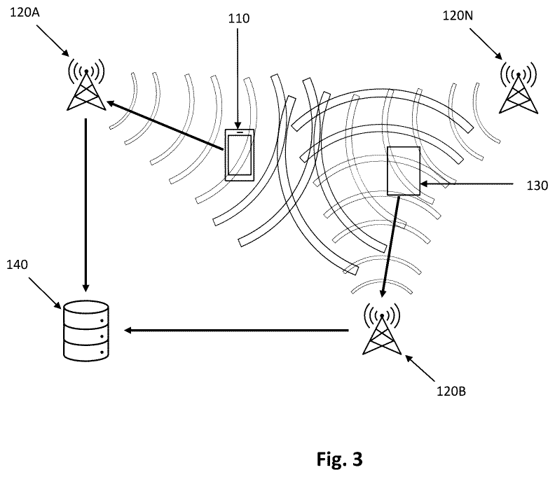

FIG. 3 illustrates an example diagram of a new radio (NR) communication system for uplink carrier phase positioning (UL CPP) in accordance with various embodiments of the present disclosure. In the depicted embodiments, the NR communication system may comprise at least one UE 110 (e.g., target UE), at least one network component 120A, 120B, 120N (collectively “120”, gNB), at least one position reference unit (PRU) 130, and/or at least one location management function (LMF) 140. In various embodiments, the UE 110 and the at least one PRU 130 are configured to transmit one or more uplink sounding reference signal (UL SRS) and multiple transmission and reception point (TRPs) measure a reference signal carrier phase (RSCP) of the UL SRS. The network component may be configured to receive said UL RSCP and transmit it to one or more LMFs 140 to determine the location of the UE 110 based on the phase measurements of the UE and the PRU, legacy time measurements of the UE and the PRU, the known locations of the TRPs, and the known location of the PRU(s) 130. In this regard, the legacy time measurements, as introduced by 3GPP Rel-16, are time and angular measurements. As CPP is not a standalone positioning method, a UE cannot rely solely on the CP measurements for positioning estimation. Instead, the legacy time measurements are also used in combination with the phase measurements to estimate the UE location. In order for the LMF 130 to accurately determine the location of the UE 110, the phase errors (e.g., UE clock bias, UE clock error, gNB clock error, etc.) need to be cancelled. The phase error may be based on various sources including initial phase offsets, oscillator drift, different beam/power levels and other hardware impairment issues.

The clock error between a target UE and TRPs and clock errors between TRPs are described below to be cancelled out using single and double differential measurements, respectively, that are expressed with mathematical notations appropriate for UL CPP. A comparable approach could be utilized to define single and double differential measurements for DL CPP. In relation to UL CPP, however, the UL SRS resource transmitted from the k^{th} UE 110 may result in a phase measurement at the i^{th} TRP may be denoted by equation (1) as follows: φᵢₖ=dᵢₖ+c (δₖ−δᵢ)+λNᵢₖ, wherein

$${φ}_{ik} = \frac{1}{2 π} {\hat{φ}}_{ik}$$

denotes the phrase measurement in cycles so as to eliminate a repeating 2π. Further, dᵢₖ represents the actual geographical distance between the k^{th} UE 110 and the i^{th} TRP, c represents the speed of light, δₖ represents the internal clock bias of the k^{th} UE 110, δᵢ represents the internal clock bias at the i^{th} TRP, and Nᵢₖ represents an integer ambiguity of the propagated wavelength. The equation noted above can be derived to equation (2) as follows: φⱼₖ=dⱼₖ+c(δₖ−δⱼ)+λNᵢₖ for the j^{th} TRP. However, an unknown phase shift exists due to the oscillator phases at the TRP and the UE 110 may add additional ambiguity due to the estimated phase for the TRP and impair the LMF from accurately determining the position of the UE. The internal clock bias of the k^{th} UE may be eliminated using a single difference measurement in which equation (2) is subtracted from equation (1) as follows: Δφᵢⱼ^{k}; =Δdᵢⱼ^{k}+cΔδᵢⱼ^{k}+λΔNᵢⱼ^{k}, wherein Δφᵢⱼ^{k}=φᵢₖ−φⱼₖ, Δdᵢⱼ^{k}=dᵢₖ−dⱼₖ, Δδᵢⱼ^{k}=δᵢ−δⱼ, and ΔNᵢⱼ^{k}=Nᵢₖ−Nᵢₖ. The single differential operation is configured to cancel the UE clock bias. In addition, the clock error between TRPs may be removed by performing a double differential measurement, which is achieved by subtracting the single-differenced measurements of the PRU from that of the k^{th} UE 110. For example, in an instance in which the p^{th} UE is the PRU that transmits the SRS, the single difference measurement between the i^{th} and j^{th} TRPs can be expressed as: Δφᵢⱼ^{p}=Δdᵢⱼ^{p}+cΔδᵢⱼ^{p}+λΔNᵢⱼ^{p}, wherein Δφᵢⱼ^{p}=φᵢₚ−φⱼₚ, Δdᵢⱼ^{p}=dᵢₚ−dⱼₚ, Δδᵢⱼ^{p}=δ₁−δⱼ, and ΔNᵢⱼ^{p}=Nᵢₚ−Nⱼₚ. As noted, the clock error between the i^{th} and j^{th} TRPs (e.g., Δδᵢⱼ^{p}) is a common term between the equations. This common term may be eliminated by double-differencing the single-differenced measurements of the k^{th} UE and the p^{th} PRU as follows: ΔΔφᵢⱼ^{kp}=ΔΔdᵢⱼ^{kp}+λΔΔNᵢⱼ^{kp}, wherein ΔΔᵢⱼ^{kp}=Δφᵢⱼ^{k}−Δφᵢⱼ^{p}, ΔΔdᵢⱼ^{kp}=Δdᵢⱼ^{k}−Δdᵢⱼ^{p}, and ΔΔNᵢⱼ^{kp}=ΔNᵢⱼ^{k}−ΔNᵢⱼ^{p}. In sum, the clock error between the target UE and TRPs and clock errors between TRPs are cancelled out using the single and double differential measurements, respectively.

The single and double differential measurements are used in carrier phase positioning (CPP) to eliminate the unknown frequency offsets between the UE and TRP and between different TRPs. The single and double differential measurements are built on the assumption, however, that the transmitted positioning reference signal resources (UL SRS and DL PRS) and the received (UL and DL) CP measurements experience the same unknown phase error. In various embodiments, however, the transmitted positioning reference signal resources (UL SRS and DL PRS) and the received (UL and DL) CP measurements do not experience the same unknown phase error due to, for example, the multiple antenna elements/panels and transmitters that are involved in the carrier phase (CP) measurements. In various embodiments, the unknown phase errors may be attributable to various hardware impairments such as initial phase offsets, oscillator drift or different beam/power levels. In the present disclosure, the CP measurement at least include a RSCP measurement, a reference signal carrier phase difference (RSCPD) measurement, and a difference between two different RSCPD measurements, where the RSCP and RSCPD measurements are defined in 3GPP TS 38.215.

Although described with respect to FIG. 3 with respect to UL CPP, the NR communication system of other embodiments provides for downlink carrier phase positioning (DL CPP) in accordance with either a UE-based mode or a UE-assisted mode. In this regard, downlink positioning reference signals (DL PRS) may be transmitted to the target UE and the PRU in DL CPP. In the UE-assisted mod of DL CPP, the target UE and/or the PRU measures the DL RSCP measurements and reports those measurements to the LMF. The LMF calculates the location of the target UE based on the phase measurements made by the target UE and the PRU and the locations of the TRPs, in addition to the legacy time measurements. Alternatively, in the UE-based mode of DL CPP, the target UE measures the DL RSCP measurements, receives simultaneous PRU measurements from the LMF and calculates its own location based on the phase measurements performed by the target UE, the PRU measurements that the target UE received from the LFM and the locations of the TPRs and the PRU, in addition to the legacy time measurements.

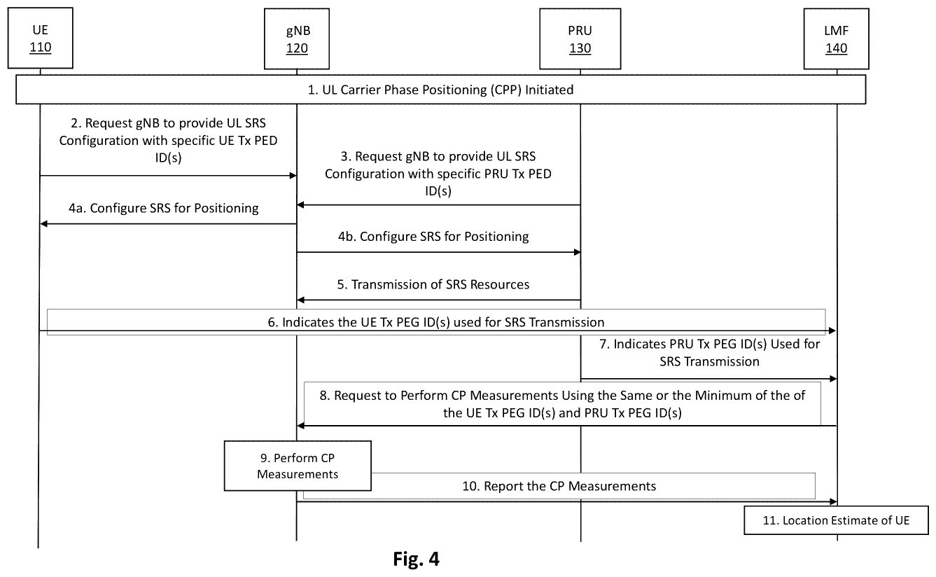

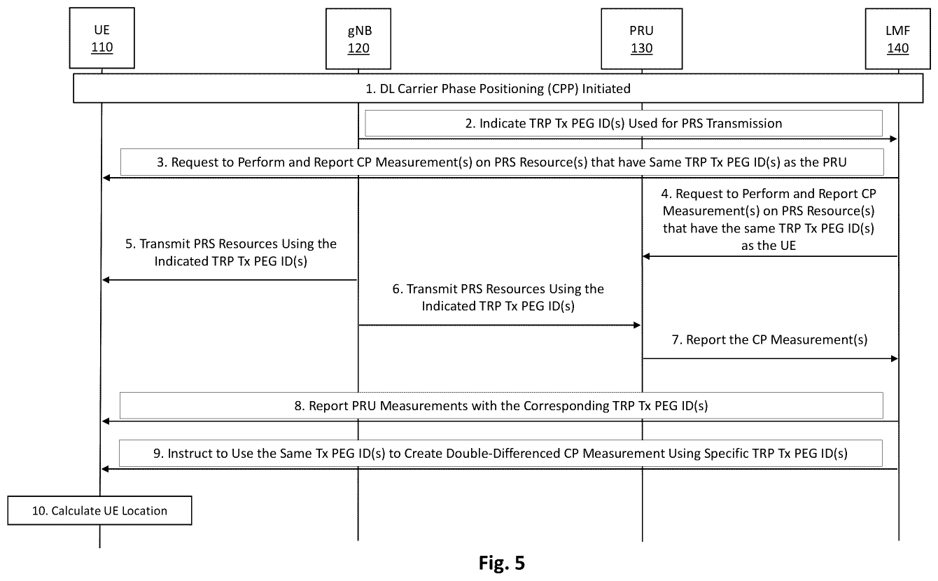

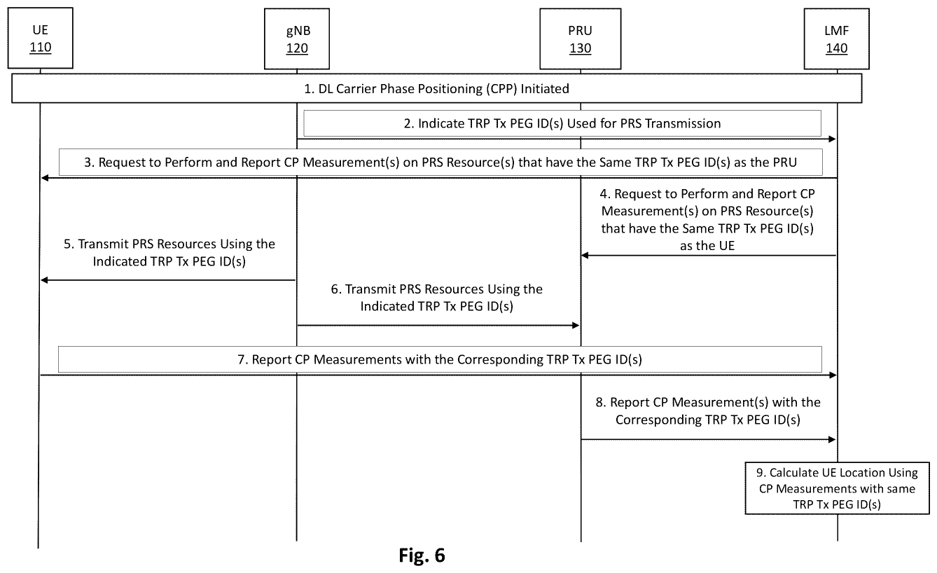

FIGS. 4-6 illustrate three example implementations of a signal flow in accordance with an example embodiment in which a user equipment is configured communicate with one or more network components and/or a location management function (LMF) in a manner that mitigates measurement errors for carrier phase positioning due to hardware impairments. In this regard, the carrier phase positioning errors are mitigated by grouping uplink and downlink resources that experience the same or nearly the same phase errors, e.g., all having a phase error within a predefined error margin, into a single group that is associated with a transmit or receive phase error group. As described below by way of example, but not of limitation, the LMF of FIGS. 4-6 is configured to assist in carrier phase positioning (CPP). In addition, FIG. 4 illustrates an uplink CPP configuration, FIG. 5 illustrates a downlink CPP UE-based configuration, and FIG. 6 illustrates a downlink CPP UE-assisted configuration.

At operation 1 (e.g., uplink configuration) of FIG. 4, an uplink carrier positioning phase (UL CPP) process may be initiated, wherein the UL CPP may involve a UE 110, a gNB 120 (representative of any of a variety of base stations or access points) associated with one or more TRPs connected to it, a PRU 130, and a LMF 140 that communicate with each other in order to determine the location of the UE 110 in a manner that mitigates phase error due to hardware impairment.

As shown in operation 2, the UE 110 may transmit a request to a gNB 120 to provide at least one uplink sounding reference signal (UL SRS) configuration with a specific UE transmission phase error group (UE Tx PEG ID), wherein the UL SRS configuration is configured to satisfy a phase error value that is less than a threshold value associated with the UE Tx PEG ID. In some embodiments, a maximum resource separation of UL SRS resources or the maximum time duration of one UL SRS resource maintains a phase error for at least a user equipment (UE) 110 that is attributable to a hardware impairment to no more than a predefined threshold. For example, to maintain the phase error from the UE 110 that is attributable to a hardware impairment to no more than the same predefined threshold, a maximum resource separation of UL SRS resources or the maximum time duration of one UL SRS resource is established. In one example in which the maximum UL SRS resource separation for which the UE 110 can maintain the phase error range to less than a predefined threshold is 2 symbols, the UE 110 will request the serving gNB to provide a proper UL SRS configuration by using UE Tx PEG ID #1 that maintains the maximum resource separation of the UL SRS resources within 2 symbols for the UL SRS transmission. Thus, the proper SRS confirmation in this example embodiment is either a 1-symbol or a 2-symbol SRS resource. For example, a UE Tx PEG ID in the mobile device can be associated with a specific Tx antenna or antenna panel, and another UE Tx PEG ID can be associated with another TX antenna or antenna panel.

In an example embodiment, the UE requests the serving gNB to provide a required UL SRS resource configuration, e.g., the number of symbols of an UL SRS resource, that will result in the phase error being less than the predefined threshold from the UE or from both the UE and the TRP. The network, such as the gNB, may configure the UL SRS resource not only to satisfy the UE request, but also based on the number of symbols that allow each TRP connected to the serving gNB to maintain the phase error less than a threshold, either the same predefined threshold or another threshold. In one embodiment, the UE 110 may further request the gNB to provide other UL SRS configuration(s) with a maximum resource separation of m symbols corresponding to UE Tx PEG ID #x subject to the capability of the UE. In this embodiment and based on the UE request, the serving gNB 120 may consider the potential impairment by each TRP. For example, if the UE can maintain the phase error to less than a predefined threshold during m (m>0) symbols and if a particular TRP can maintain the phase error to less than a threshold n (n>0) symbols, the serving gNB may decide the time duration of the SRS to be the minimum of m and n, e.g. min (m,n).

As shown in operation 3, the PRU 130 may transmit a request to the gNB to provide any necessary UL SRS configuration(s) with a specific PRU Tx PEG ID(s). In various embodiments, operation 3, the UL SRS configurations, and the specific PRU Tx PEG ID(s) may be determined as described above in relation to the UE in operation 2.

As shown in operations 4a and 4b, the gNB 120 configures the UL SRS resources for positioning based upon and satisfying the UE/PRU Tx PEG ID(s) provided by the UE and the PRU. In this regard, the gNB 120 provides the configuration of the UL SRS resources to the UE and the PRU in operations 4a and 4b, respectively.

As shown in operations 5a and 5b, the UE and the PRU 130 may be configured to transmit their UL SRS resources and/or capabilities to the TRPs of the serving gNB upon receiving the UL SRS configurations for CPP.

As shown in operation 6, the PRU 130 may be also be configured to indicate to at least one LMF 140 the UE Tx PEG ID(s) used for the UL SRS transmission. For example, in an instance in which the maximum UL SRS resource separation for which the UE can maintain an error range to less than a certain threshold is 2 symbols, the UE is configured to indicate to the LMF that the UE supports up to the maximum UL SRS resource separation of 2 symbols, which corresponds to and is designated by UE Tx PEG #1.

As shown in operation 7, the PRU 130 may also be configured to indicate to at least one LMF 140 the PRU Tx PEG ID(s) used for the UL SRS transmission. For example, in an instance in which the maximum UL SRS resource separation for which the PRU can maintain an error range to less than a certain threshold is 4 symbols, the PRU is configured to indicate to the LMF that the PRU supports up to the maximum UL SRS resource separation of 4 symbols, which corresponds to and is designated by PRU Tx PEG #2.

As shown in operation 8 and in response to receiving the UE Tx PEG ID(s) and PRU Tx PEG ID(s), the LMF 140 may transmit a request to the serving gNB and/or neighbor gNBs to perform carrier phase (CP) measurements using the same phase error margins corresponding to the transmitted UE Tx PEG ID(s) and/or PRU Tx PEG ID(s) of the received UL SRS transmission from the UE 110 and PRU 130, respectively. In instance in which the phase error margins provided by the UE and the PRU are different, the LMF 140 maytransmit a request to the serving gNB and/or neighbor gNBs to perform CP measurements using the minimum of the different phase error margins. For example, if the UE 110 may support a maximum UL SRS resource separation of up to two symbols (e.g., UE Tx PEG #1) and the PRU 130 may support a maximum UL SRS resource separation of up to four symbols (e.g., PRU Tx PEG ID #1 and PRU Tx PEG ID #2) to maintain the phase error within the predefined threshold, the LFM 140 may request the serving gNB and/or neighbor gNBs to perform CP measurements for only two symbols. In some embodiments, the gNB may be configured to cancel a received signal(s) on UL SRS resources having a greater separation value than that requested by the LMF 140, e.g., greater than two symbols. By canceling the received signal, the gNB does not perform CP measurements using these signals.

As shown in operation 9, the TRPs receive the UL SRS transmissions from the UE and the PRUs and perform carrier phase (CP) measurements, based on the received UE Tx PEG ID(s) and PRU Tx PEG ID(s). As shown in operation 10, the gNBs transmit information regarding the CP measurements to at least a location management function (LMF) 140. As shown in operation 11, the LFM 140 then receives information regarding the CP measurements and the CP measurements of the UL SRS provided by the PRU and the UE to perform the single-differenced and double-differenced CP measurements. The LMF 140 may utilize the received UE Tx PEG IDs and PRU Tx PEG IDs to conduct the single-differencing and/or double-differencing operations between the CP measurements that only have the same UE Tx PEG IDs and PRU Tx PEG IDs (e.g., having the phase error within the same predefined threshold) to accurately determine the location of the UE 110 by having mitigated the phase errors associated with hardware impairments of the UE, the PRU or between the UE and the PRU and other elements.

While the operations describe with respect to FIG. 4 were for uplink carrier phase positioning (UL CPP), the operations describe with respect to FIGS. 5-6 relate to downlink CPP. The DL CPP comprises two different modes (e.g., UE-based mode and UE-assisted mode). In various embodiments, operations 1-6 for both the UE-based mode (depicted in FIG. 5) and the UE-assisted mode (depicted in FIG. 6) are the same.

Referring now to FIGS. 5-6, as shown in operation 1, a downlink carrier positioning phase (DL CPP) process may be initiated. During the DL CPP a UE 110, a gNB 120, a PRU 130, and/or a LMF 140 communicate with each other as described below.

As shown in operation 2, the gNBs 120 may report to the LMF at least one TRP transmission phase error group identifier (TRP Tx PEG ID(s)) to be used for transmitting the DL positioning reference signals (PRS). The TRP Tx PEG ID defines a maximum DL PRS resource separation that the TRP can use to maintain the phase error within a predefined threshold. For example, if the TRP may support a maximum DL SRS resource separation of up to two symbols (e.g., TRP Tx PEG #1) to maintain the phase error within a predefined threshold, the gNB 120 may further indicate to the LMF 140 a corresponding TRP Tx PEG ID to be used for the transmission of the DL PRS resources. In various embodiments, the maximum resource separation maintains a phase error from at least one TRP that is attributable to a hardware impairment to no more than a predefined threshold. In some embodiments, the gNB 120, subject to the network capability, may additionally and/or alternatively report to the LMF 140 one or more additional TRP Tx PEG ID(s) that is used to transmit other configurations of the DL PRS resources. In various embodiments, a PRS resource separation may be a number of symbols and/or a time duration that the TRP can guarantee a phase error caused by hardware impairments less than a predefined or configured threshold while transmitting a single DL PRS resource or multiple DL PRS resources. In an instance in which there are multiple DL PRS resources, the resource separation may include the time gap between DL PRS resources. For the threshold value of error, the PRS resource separation may be predefined by the hardware specification or determined by the device. In one embodiment, the LMF may provide multiple threshold values to the UEs and gNBs, and the LMF may request the the threshold values to determine Tx PEG IDs based on the provided threshold values.

As shown in operations 3 and 4, the LMF 140 may transmit a request to the UE 110 and/or the PRU 130 to perform carrier phase (CP) measurements using the DL PRS resource(s)/resource set(s) that have the same TRP Tx PEG ID(s). In some embodiments, the request may further include a request to the UE 110 and/or the PRU 130 to transmit the CP measurements that comprise a specific TRP Tx PEG ID to the LMF 140, along with an indication of the associated TRP Tx PEG ID. In one embodiment, the LMF also provides an indication of the CP technique, e.g., UE-assisted or UE-based) to the UE and the PRU.

As shown in operations 5 and 6, the gNB 120 may transmit one or more DL PRS resources in accordance with the TRP transmission phase error group identifier(s) (TRP Tx PEG ID(s)) that defines a maximum DL PRS resource separation. In some embodiments, the maximum DL PRS resource separation maintains a phase error from at least TRP that is attributable to a hardware impairment to no more than a predefined threshold.

Referring now to FIG. 5, a UE-based mode DL CPP is depicted and at operation 7 the PRU obtains one or more CP measurement(s) from the DL PRS transmitted by the at least one gNB(s) 120 and is then configured to transmit the CP measurement information along with the associated TRP Tx PEG ID(s) to the LMF 140. As shown in operation 8, the LMF 140 receives the one or more CP measurement(s) from the PRU 130 along with the associated TRP Tx PEG ID(s) and further forwards these CP measurement(s) along with the associated TRP Tx PEG ID(s) to the UE 110, wherein the PRU CP measurement further comprises a single differenced CP measurement of the PRU.

As shown in operation 9, the LMF 140 may also transmit instructions towards the UE 110, either concurrently with the PRU CP measurement(s) or separate therefrom. The UE is configured to use specific TRP Tx PEG ID(s) associated with the CP measurements from the PRU (which are identical to the TRP Tx PEG ID(s) as described above in elation to operation 3 of FIG. 5 by the LMF 140 to the UE 110 be used to perform its own CP measurements) to create double-differenced CP measurements between its own single-differenced CP measurement and the single-difference CP measurements of the PRU.

As shown in operation 10, the UE 110 may be configured to receive and use at least one TRP transmission phase error group identifier (TRP Tx PEG ID) associated with the CP measurements of the PRU to create the double-differenced CP measurements. The UE 110 may then use the double-differenced CP measurement(s), the legacy time measurements, the known locations of the TRPs 120, and the known location of the PRU 130 to determine the UE location.

Referring now to FIG. 6, a UE-assisted mode DL CPP is depicted and at operation 7, the UE 110 may use the received DL PRS to perform a CP measurement(s) and to then transmit information regarding the CP measurement(s) along with the associated TRP Tx PEG ID(s) to the LMF 140 in order to assist with DL CPP. At operation 8, the PRU 130 may also use the received DL PRS to perform a CP measurement(s) and to then transmit information regarding the CP measurement(s) along with the associated TRP Tx PEG ID(s) to the LMF 140 in order to assist with DL CPP.

At operation 9, the LMF 140 may receive one or more CP measurement(s) from the UE 110 and/or the PRU 130 along with the associated TRP Tx PEG ID(s). In various embodiments, the LMF 140 may utilize one or more CP measurement(s) from the UE and the PRU associated with identical TRP Tx PEG ID(s) to create the double-differenced CP measurements and determine the location of the UE 110 in a manner that mitigates inaccuracies otherwise introduced by hardware impairments.

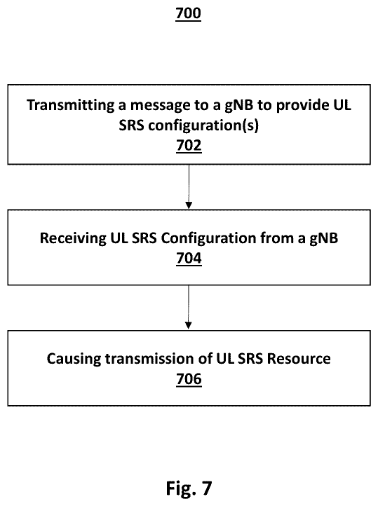

Referring now to FIGS. 7-11, example flowcharts of the operations performed by an apparatus, such as the apparatus of FIG. 2 embodied by a UE/PRU, an LMF, a gNB in an uplink configuration, and a gNB in a downlink configuration, respectively. Referring to FIG. 7, a method 700 is illustrated that can be carried out by an apparatus as embodied by a UE or a PRU with the apparatus including means, such as the processor 202, the memory 204, the network interface 206 or the like, for transmitting a message to at least one gNB 120. The message may comprise a request for the gNB 120 to provide at least one UL SRS configuration(s). In various embodiments, the UL SRS configuration(s) is configured to maintain no more than a maximum resource separation of UL SRS resources or a maximum time duration of one UL SRS resource as defined by a UE transmission phase error group identifier (UE Tx PEG ID(s)) or a PRU transmission phase error group identifier (PRU Tx PEG ID(s)). In various embodiments, the maximum resource separation of UL SRS resources or a maximum time duration of one UL SRS resource maintains a phase error from at least the UE that is attributable to a hardware impairment of no more than a predefined threshold. In other embodiments, the maximum resource separation maintains of UL SRS resources or a maximum time duration of one UL SRS resource a phase error between the UE and/or PRU and the gNB that is attributable to a hardware impairment to no more than a predefined threshold.

The apparatus further includes means, such as the processor 202, the memory 204, the network interface 206 or the like, for receiving at least one UL SRS configuration from at least one gNB 120, at 704. In various embodiments, the UL SRS configuration may be configured to maintain no more than the maximum resource separation of UL SRS resources or a maximum time duration of one UL SRS resource as defined by the UE Tx PEG ID(s) and/or the PRU Tx PEG ID(s).

The apparatus also includes means, such as the processor 202, the memory 204, the network interface 206 or the like, for causing transmission of at least one UL SRS resource, at 706. In various embodiments, the UE 110 may transmit the at least one UL SRS resource to the gNB 120. The UL SRS resource may be based at least in part on the UL SRS configuration received by the gNB 120.

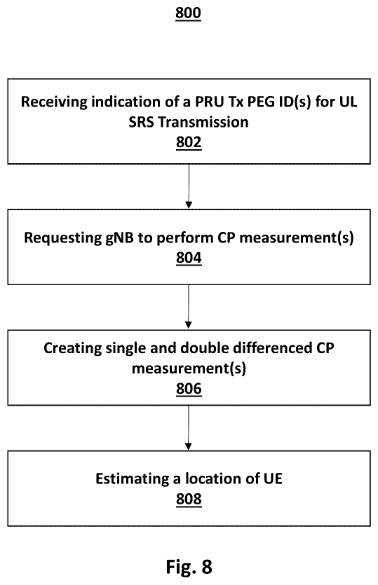

Referring to FIG. 8, a method 800 is illustrated that can be carried out by an apparatus as embodied by a LMF in the uplink configuration with the apparatus including means, such as the processor 202, the memory 204, the network interface 206 or the like, for receiving at least one indication from a PRU 130. The indication comprises at least one PRU Tx PEG ID(s) to be used for SRS transmission based on the capability of the PRU 130. For example, if the maximum SRS resource separation that PRU 130 can maintain a certain error range less than a predefined threshold of phase error (n) is four symbols, the PRU 130 indicates to LMF 140 that the PRU supports a maximum UL SRS resource separation of up to four symbols by providing the corresponding PRU Tx PEG ID.

The apparatus further includes means, such as the processor 202, the memory 204, the network interface 206 or the like, for requesting a gNB 120 to perform at least one CP measurement, at 804. In various embodiments, the at least one CP measurement may be based at least in part on the PRU Tx PEG ID(s) that the LMF received from the PRU 130.

The apparatus further includes means, such as the processor 202, the memory 204, the network interface 206 or the like, for creating a single-differenced CP measurement and a double-differenced CP measurement, at 806. In various embodiments, the single-differenced CP measurement and the double-differenced CP measurement may be based at least in part on one or more received UE Tx PEG ID(s), PRU Tx PEG ID(s), and/or TRP Tx PEG ID(s). The single differential operation may be configured to remove a clock bias (e.g., UE clock bias, PRU clock bias, etc.), between the UE/PRU and at least one TRP, while the double differential operation may be configured to cancel the clock error between different TRPs.

The apparatus further includes means, such as the processor 202, the memory 204, the network interface 206 or the like, for estimating a location of the UE 110, at 808. In various embodiments, the LMF 140 may be configured to utilize the CP measurements from the PRU and the UE for which the Tx PEG ID(s) is (are) identical to create and use single-differenced and double-differenced CP measurements in order to estimate the UE location. By maintaining the maximum resource separation for the UL SRS resources from which the CP measurements are obtained, the phase error from at least the UE, the gNB, and/or the PRU that is attributable to a hardware impairment is limited to be no more than a predefined threshold.

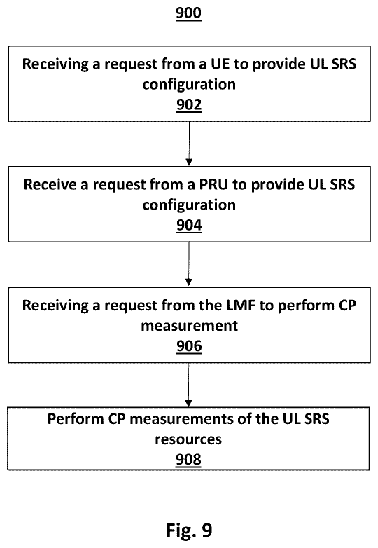

Referring to FIG. 9, a method 900 is illustrated that can be carried out by an apparatus as embodied by a gNB in the uplink configuration with the apparatus including means, such as the processor 202, the memory 204, the network interface 206 or the like, for receiving a request from a UE 110 to provide at least one uplink sounding reference signal (UL SRS) configuration, at 902. In various embodiments, at least one UL SRS configuration may be configured to maintain no more than a first maximum resource separation from the UE as defined by a first UE transmission phase error group identifier(s) (UE Tx PEG ID(s)). The apparatus of an example embodiment further includes means, such as processor 202, the memory 204, and network interface 206 and/or the like for receiving a request from a PRU 130 to provide at least one uplink sounding reference signal (UL SRS) configuration, at 904. In various embodiments, at least one UL SRS configuration may be configured to maintain no more than a second maximum resource separation from the PRU as defined by a second PRU transmission phase error group identifier(s) (PRU Tx PEG ID(s)) . . . . In this example embodiment, the first UE Tx PEG ID and second PRU Tx PEG ID may define the same maximum resource separation or different maximum resource separations. In an instance in which the first and second maximum resource separations are different, the gNB 120 may be configured to perform CP measurements for UL SRS resources having a maximum resource separation of no more than a smaller of the first and second maximum resource separations.

The apparatus further includes means, such as processor 202, the memory 204, and network interface 206 and/or the like for receiving a request from a LMF 130 to perform at least one CP measurement, at 906. In various embodiments, the request may comprise using the same (or minimum of) phase error margin(s) corresponding to the UE Tx PEG ID(s) and the PRU Tx PEG ID(s). For example, if the UE supports maximum UL SRS resource separation of up to two symbols (e.g., only UE Tx PEG #1) and the PRU supports maximum UL SRS resource separation of up to four symbols (e.g., PRU Tx PEG #1 and PRU Tx PEG #2) to maintain the phase within a predefined threshold, the LMF 140 may request the gNB 120 to perform CP measurement for only two symbols although the configured SRS resource is composed of four symbols.

The apparatus further includes means, such as processor 202, the memory 204, and network interface 206 and/or the like for performing at least one CP measurement(s) of the UL SRS resources received, at 908. In various embodiments, the CP measurement(s) may be based at least in part on first and second Tx PED ID(s) (e.g., UE Tx PEG ID(s) and PRU Tx PEG ID(s)). In some embodiments, the performing of the CP measurements comprises preventing performance of the CP measurements for UL SRS resources having a resource separation that is greater than the smaller of the first and second maximum resource separations. In some embodiments, the first maximum resource separation maintains a phase error from the UE that is attributable to a hardware impairment to no more than a first predefined threshold, and the second maximum resource separation maintains a phase error from the PRU that is attributable to a hardware impairment to no more than a second predefined threshold.

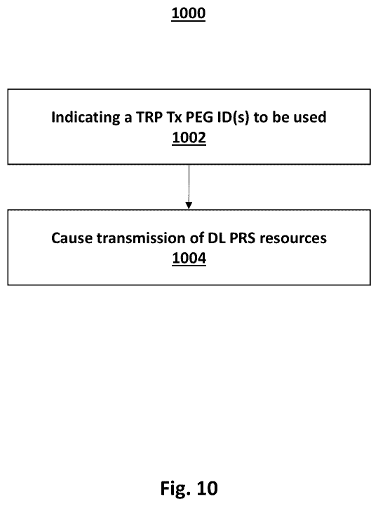

Referring to FIG. 10, a method 1000 is illustrated that can be carried out by an apparatus as embodied by a gNB in the downlink configuration with the apparatus including means, such as the processor 202, the memory 204, the network interface 206 or the like, for indicating at least one TRP transmission phase error group identifier (TRP Tx PEG ID(s)) to be used for transmitting the DL positioning reference signal (PRS) resources, at 1002. In various embodiments, the TRP Tx PEG ID(s) is configured to define a maximum DL PRS resource separation of DL PRS resources received at the UE and/or the PRU from multiple TRPs. In various embodiments, the maximum DL PRS resource separation may maintain a phase error from at least one TRP that is attributable to a hardware impairment to no more than a predefined threshold.

The apparatus further includes means as processor 202, the memory 204, and network interface 206 and/or the like for causing the transmission of the PRS resources based upon the TRP Tx PEG ID so as to maintain no more than the maximum DL PRS resource separation, at 1004. In various embodiments, the gNB 120 may transmit the DL PRS resources to the UE 110 and the PRU.

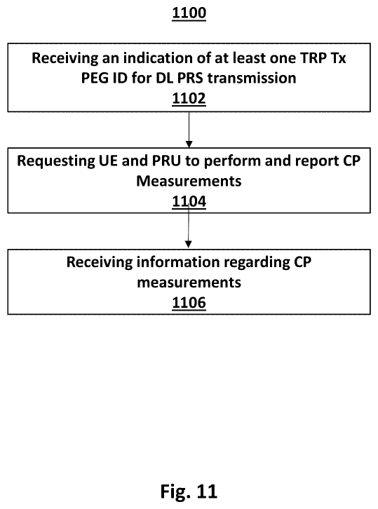

Referring to FIG. 11, a method 1100 is illustrated that can be carried out by an apparatus as embodied by a LMF in the downlink configuration with the apparatus including means, such as the processor 202, the memory 204, the network interface 206 or the like, for receiving an indication of at least one TRP transmission phase error group identifier (TRP Tx PEG ID) to be used for transmitting the DL positioning reference signal (PRS) resources, at 1102. In various embodiments, the TRP Tx PEG ID may be configured to be used for transmission of the DL PRS resources to the UE 110 and/or the PRU 130. In some embodiments, the TRP Tx PEG ID(s) may be further configured to define a maximum DL PRS resource separation of the DL PRS resources received at the UE and/or the PRU from multiple TRPs.

The apparatus further includes means such as processor 202, the memory 204, and network interface 206 and/or the like for requesting a UE and a PRU to perform and report CP measurements, at 1104. In various embodiments, the CP measurements may be based at least in part on DL PRS resources that have no more than the maximum DL PRS resource separation defined by the TRP Tx PEG ID. The apparatus further includes means such as processor 202, the memory 204, and network interface 206 and/or the like for receiving information regarding the CP measurements, at 1106. In some embodiments, the LMF 140 may use the received information regarding the CP measurements to determine the location of the UE 110. In other embodiments, the LMF 110 may be configured to transmit the PRU CP measurement information to the UE 110 to assist the UE in calculating its location.

FIGS. 7-11 illustrate flowcharts depicting operations according to an example embodiment of the present disclosure. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures or operations described above may be embodied by computer program instructions. In this regard, the computer program instructions which embody the procedures or operations described above may be stored by a memory 204 of an apparatus (e.g., apparatus 200, UE 110) employing an embodiment of the present invention and executed by a processor 202. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus comprising:
at least one processor;
at least one memory storing instructions that, when executed by the at least one processor, cause the apparatus at least to:
transmit a message to request a network element to provide at least one sounding reference signal (SRS) configuration satisfying a phase error less than a threshold value associated with a user equipment (UE) transmission phase error group identifier (UE Tx PEG ID);
receive at least one SRS configuration in response to the request; and
cause SRS transmission using uplink SRS resources based upon the received at least one SRS configuration.

2. The apparatus of claim 1, wherein the instructions, when executed by the at least one processor, further cause the apparatus to cause at least one of a positioning reference unit (PRU) or a user equipment (UE) to indicate to a location management function (LMF) at least one of the PRU Tx PEG ID or UE Tx PEG ID used for the SRS transmission.

3. The apparatus of claim 1, wherein a maximum resource separation of uplink SRS resources or a maximum time duration of one uplink SRS resource defined by the UE Tx PEG ID maintains a phase error from at least a user equipment (UE) that is attributable to a hardware impairment to no more than a threshold.

4. The apparatus of claim 1, wherein a maximum resource separation or a maximum time duration of one SRS resource maintains a phase error from a user equipment (UE) and the network element that is attributable to a hardware impairment to no more than a threshold.

5. The apparatus of claim 1, wherein a maximum resource separation of uplink SRS resources or a maximum time duration of one uplink SRS resource maintains a phase error from at least a PRU that is attributable to a hardware impairment to no more than a threshold.

6. The apparatus of claim 1, wherein the message further includes a request for the network element to maintain a phase error that is less than a threshold value when the network element performs carrier phase measurements for the at least one uplink SRS resources.

7. The apparatus of claim 1, wherein the received at least one SRS configuration satisfies a phase error less than a threshold value associated with at least one of a UE or a PRU transmission phase error group identifier(s) (UE Tx PEG ID(s) and/or PRU Tx PEG ID(s)).

8. The apparatus of claim 1, wherein the apparatus comprises or is comprised in a user equipment.

9. The apparatus of claim 1, wherein the apparatus comprises or is comprised in a positioning reference unit.

10. An apparatus comprising:
at least one processor; and
at least one memory storing instructions that, when executed by the at least one processor, cause the apparatus at least to:
receive a request from a user equipment (UE) to provide at least one uplink sounding reference signal (UL SRS) configuration to maintain no more than a first maximum resource separation of UL SRS resources or a first maximum time duration of one UL SRS resource from the UE as defined by a first UE transmission phase error group identifier (UE Tx PEG ID);
receive a request from at least one positioning reference unit (PRU) to maintain no more than a second maximum resource separation of UL SRS resources or a second maximum time duration of one UL SRS resource from the PRU as defined by a second PRU Tx PEG ID;
receive a request to perform carrier phase (CP) measurements based on the first UE Tx PEG ID and second PRU Tx PEG ID; and
based on the first UE Tx PEG ID and second PRU Tx PEG ID, performing the CP measurements of the SRS resources that have been received.

11. The apparatus of claim 10, wherein the instructions, when executed by the at least one processor, further cause the apparatus to cause transmission of information regarding the CP measurements to at least a location management function (LMF).

12. The apparatus of claim 10, wherein, in an instance in which the first and second maximum resource separations or maximum time durations are different, performing the CP measurements comprises performing the CP measurements for UL SRS resources having a maximum resource separation or UL SRS resource having maximum time duration of no more than a smaller of the first and second maximum resource separations or the first and second maximum time durations.

13. The apparatus of claim 12, wherein performing the CP measurements comprises preventing performance of the CP measurements for UL SRS resources having a resource separation that is greater than the smaller of the first and second maximum resource separations or the first and second maximum time durations.

14. The apparatus of claim 10, wherein the first maximum resource separation or the first maximum time duration maintains a phase error from the UE that is attributable to a hardware impairment to no more than a first threshold, and wherein the second maximum resource separation or the second maximum time duration maintains a phase error from the PRU that is attributable to a hardware impairment to no more than a second threshold.

15. An apparatus comprising:
at least one processor; and
at least one memory storing instructions that, when executed by the at least one processor, cause the apparatus at least to:
receive one or more indications of at least one position reference unit (PRU) transmission phase error group identifier(s) (PRU Tx PEG ID(s)) for uplink sounding reference signal (UL SRS) transmission, wherein the PRU Tx PEG ID(s) defines a maximum resource separation of UL SRS resources or a maximum time duration of one UL SRS resource;
request that a network element to perform carrier phase (CP) measurements for the UL SRS resources as associated with the PRU Tx PEG ID(s) and report the CP measurements;
create single and double differenced CP measurements based on the received PRU Tx PEG ID(s); and
estimate a location of a user equipment (UE) based on the CP measurements.

16. The apparatus of claim 15, wherein the instructions, when executed by the at least one processor, further cause the apparatus to receive the CP measurements from the network element.

17. The apparatus of claim 16, wherein the instructions, when executed by the at least one processor, further cause the apparatus to utilize the CP measurements from the PRU and the UE for which the Tx PEG ID(s) is (are) identical to create the single-differenced and double-differenced CP measurements.

18. The apparatus of claim 15, wherein the maximum resource separation maintains a phase error from at least the UE that is attributable to a hardware impairment to no more than a predefined threshold.

19. The apparatus of claim 15, wherein the maximum resource separation maintains a phase error from at least the PRU that is attributable to a hardware impairment to no more than a predefined threshold.

20. The apparatus of claim 15, wherein the maximum resource separation maintains a phase error from the UE and the network element that is attributable to a hardware impairment to no more than a predefined threshold.
